(19) United States
(12) Patent Application Publication
(10) Pub. No.: US 2006/0117568 A1
(43) Pub. Date: Jun. 8, 2006

(54) Heated razor cartridge

(76) Inventor: Louis D. Tomassetti, Pompano Beach, FL (US)

Correspondence Address: Robert M. Downey, Esq., Suite 300, 601 South Federal Highway, Boca Raton, FL, 33432, US

(21) Appl. No.: 11/293,514

(22) Filed: Dec. 2, 2005

Related U.S. Application Data
(60) Provisional application No. 60/633,298, filed on Dec. 3, 2004.

(51) Int. Cl. B26B 19/00; B26B 21/40

(52) U.S. Cl. 30/34.05; 30/537

(57) ABSTRACT

A razor having a handle, a neck extending from the handle and a blade carrying cartridge, includes at least one heat storing element for time release of heat energy in order to warm one or more parts of the razor. Prior to use of the razor, the heat storing element is heated to a temperature within a predetermined temperature range. During use of the razor to shave body hair, heat stored in the element is released to warm the blades, handle and/or other portions of the razor. In one embodiment, the heat storing element(s) is heated by an external device, such as a heated tray. In another embodiment, the razor is provided with an internal battery powered heat generating device.

### BACKGROUND OF THE INVENTION

This application is based on provisional patent application, U.S. Serial No. 60/633,298 filed on Dec. 3, 2004.

1. Field of the Invention

The present invention relates to a heated razor for shaving and, more particularly, to a razor having a heat holding element (e.g. heat sink material) for storing heat and releasing heat, throughout a time interval, to thereby warm the blades of the razor.

2. Discussion of the Related Art

When shaving with a razor, it is preferable to warm the blades of the razor prior to applying the blade cartridge against the skin surface. Warming the blades in this manner provides added comfort when shaving. Additionally, it is believed that warming the blades enhances the performance of the razor by cutting the hairs more effectively. Presently, people who shave with a razor attempt to warm the blades by holding the blade cartridge under hot running water. While this method helps to warm the temperature of the blade cartridge, and the blades carried therein, the heat quickly dissipates after just one or two strokes of the razor along the skin surface. In order to maintain the desired warm temperature of the blade cartridge and blades for maximum comfort, it is necessary to repeatedly hold the razor cartridge under hot running water throughout the shaving process.

The present invention provides a means to maintain the blade cartridge, blades, handle and/or other portions of a razor at a desired warm temperature for an extended period of time, thereby enhancing the comfort and performance of the razor throughout the entire shaving process.

### OBJECTS AND ADVANTAGES OF THE INVENTION

It is a primary object of the present invention to provide a razor with an internal heat holding and/or generating source for warming the blades and other portions of the razor throughout the time required to normally shave.

It is a further object of the present invention to provide a razor with a heat holding element which is structured and disposed to absorb heat energy and release heat over a period of time in order to warm the blades, handle and/or other portions of the razor throughout the time required to shave.

It is a further object of the present invention to provide a razor with an internal heat storage source which is adapted for transferring heat to one or more blades of the razor so that the blades are warmed to a temperature within a desired temperature range throughout the time required to shave using the razor.

It is a further object of the present invention to provide a razor which is structured and disposed to warm the blades, thereby providing a more comfortable shave using the razor.

It is a further object of the present invention to provide a razor which is structured and disposed to warm the blades throughout the time required to shave using the razor, thereby enhancing the cutting performance of the razor.

It is still another object of the present invention to provide an internal heat generating device in a razor for heating the blades, handle and/or other parts of the razor.

It is yet a further object of the invention to warm both the blades and the handle of a razor for added comfort.

These and other objects and advantages of the present invention are more readily apparent with reference to the following detailed description and accompanying drawings.

### SUMMARY OF THE INVENTION

The present invention is directed to a razor having a handle, a neck extending from the handle and a blade carrying cartridge. The razor includes at least one heat storing element for time release of heat energy in order to warm one or more parts of the razor. Prior to use of the razor, the heat storing element is heated to a temperature within a predetermined temperature range. During use of the razor to shave body hair, heat stored in the element(s) is released to warm the blades, handle and/or other portions of the razor. In one embodiment, the heat storing element(s) is heated by an external device, such as a heated tray. In another embodiment, the razor is provided with an internal battery powered heat generating device.

### BRIEF DESCRIPTION OF THE DRAWINGS

For a fuller understanding of the nature of the present invention, reference should be made to the following detailed description taken in conjunction with the accompanying drawings in which:

FIG. 1 is top perspective view of the razor of the present invention shown in conjunction with an electrically powered heating tray;

FIG. 2 is a top perspective view showing the razor of FIG. 1 seated within the cradle of the electrically powered heating tray for heating a heat storage source in the razor;

FIG. 3 is a side elevational view showing the razor of FIG. 1 seated in the cradle of the heating tray;

FIG. 4 is an isolated side view, in partial cross-section, showing a heat storage element of the razor in accordance with one preferred embodiment thereof;

FIG. 5 is an isolated top plan view of the head of the razor and blade carrying cartridge, wherein the heat storage element is indicated in broken lines;

FIG. 6 is an isolated side view, in cross-section, showing a blade carrying cartridge in accordance with another embodiment of the invention;

FIG. 7 is a front elevational view of the blade face of the blade carrying cartridge, showing yet a further embodiment of the present invention; and

FIG. 8 is a top perspective view, in partial cutaway, showing a further embodiment of the invention which includes an internal battery powered heat generating device.

Like reference numerals refer to like parts throughout the several views of the drawings.

### DETAILED DESCRIPTION OF THE PREFERRED EMBODIMENTS

As shown throughout the several views of the drawings, a razor is generally indicated as 10 and includes a handle 12, a neck 14 extending from the handle and a blade carrying cartridge 16 connected to the neck. The cartridge 16 has one or more blades 18. In each of the several embodiments shown throughout the drawings, the blades 18 are heated to a temperature within a predetermined temperature range. The handle 12 of the razor, and any contents therein (e.g. a shaving product such as cream or gel) may also be heated.

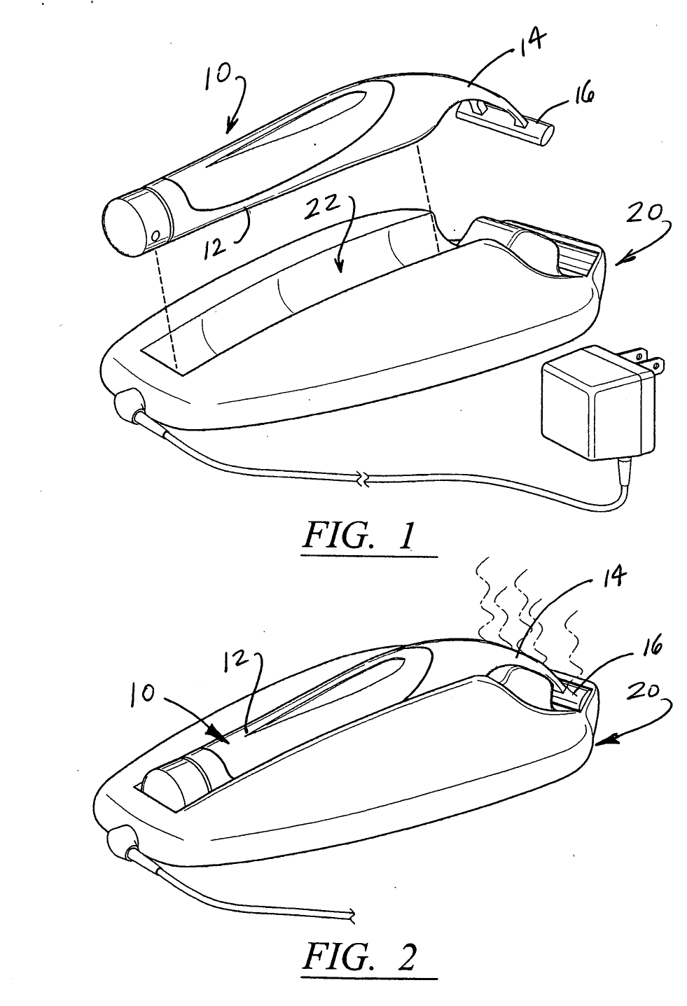

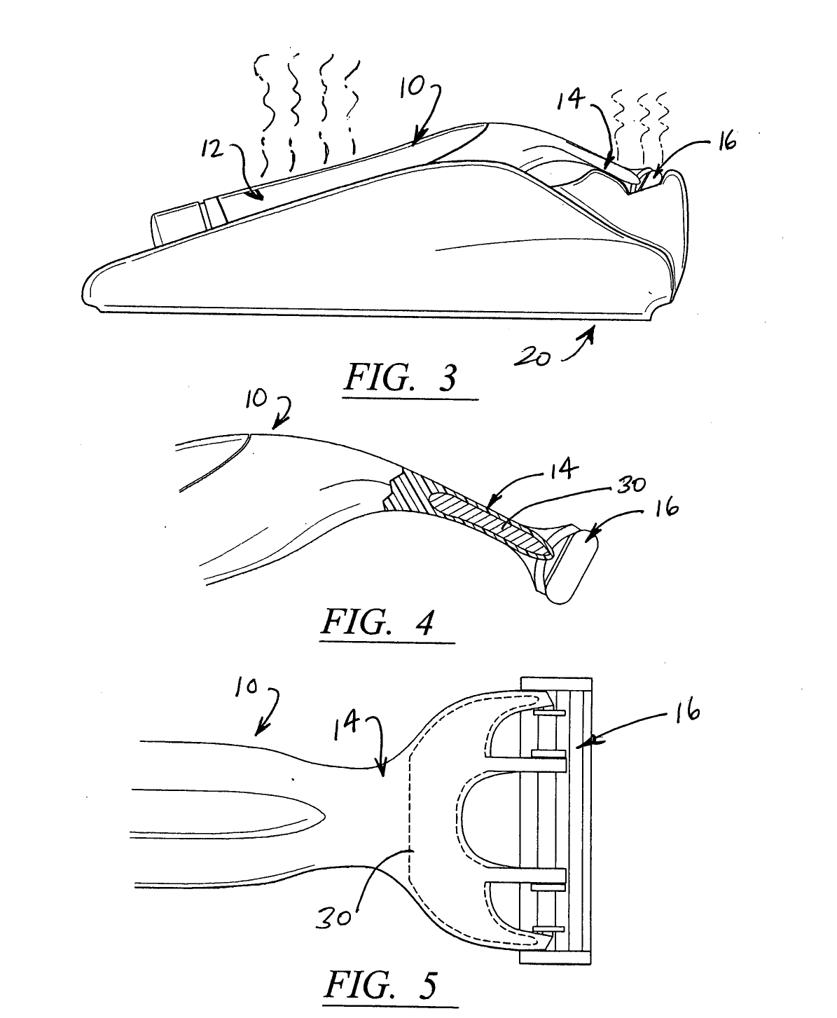

Referring to FIGS. 1-7, several embodiments of the razor 10 are shown, wherein the blades 18 and/or handle 12 (including any contents within the handle) are heated by an external heat source. An example of an external heat source is shown in FIGS. 1-3. In particular, a tray 20 with a cradle 22 for holding the razor 10 is provided with electric heat generating elements that are operatively positioned within the cradle 22 for transferring heat to the blades 18 of the razor when the razor 10 is seated within the cradle, as illustrated in FIG. 2. The electric heat generating elements may further be positioned along the handle supporting portion of the cradle for warming the handle 12 of the razor 10, as well as any contents carried within the handle, such as a shaving product (e.g. shave cream or shave gel). FIG. 3 illustrates the handle 12 and blades 18 (see also FIG. 7) within the blade cartridge 16 being heated while the razor 10 rests within the cradle of the tray 20.

In order to enhance the heat holding capacity, the razor 10 is provided with one or more heat storing elements 30. The heat storing elements 30 are of a suitable material composition (e.g. heat sink material) adapted to store and transfer heat for an extended time period which is sufficient to last throughout the time normally required to shave. More particularly, the heat storing elements release stored heat over a period of at least one minute and preferably several minutes to maintain the blades, handle, and/or other portions of the razor, warm throughout the shave time. The heat storing element(s) 30 is heated by the heat generating source and is specifically positioned and disposed for time release radiant transfer of heat to the one or more blades 18 in the cartridge. One or more heat storing elements may further be located in the handle 12 of the razor for releasing heat over an extended period of time, at least as long as the time which is normally required to shave, so that the handle remains warm to the user throughout the shaving process. This serves to provide added comfort while shaving, particularly in colder climates.

As seen in FIGS. 4 and 5, one embodiment of the invention provides the heat storing element 30 within the neck 14 of the razor, in heat transferring relation to the blades 18 in the cartridge 16, by radiant transfer, without directly contacting the blades. The heat storing element 30 is heated by a heat generating source (internal or external) and transfers heat to warm the blades over a period of time, preferably several minutes.

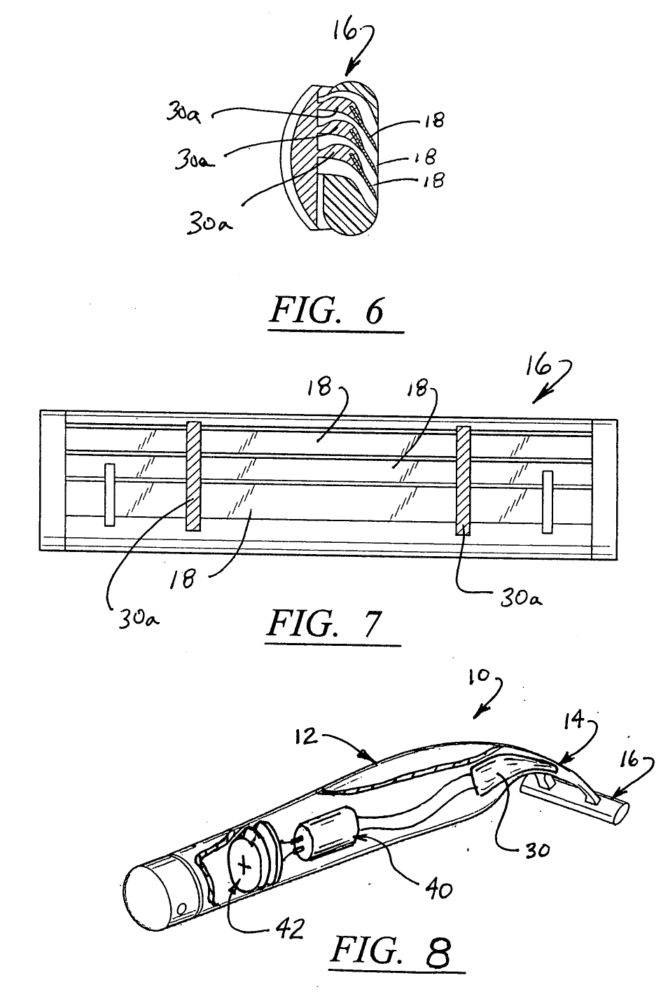

FIGS. 6 and 7 illustrate a further embodiment which provides several heat storing elements 30a on the blade cartridge and in direct contact with the blades 18. In this particular embodiment, the heat storing elements 30a are heated by the external heating source, such as the tray shown in FIGS. 1-3. Once heated, the heat storing elements 30a are adapted to transfer heat to the blades, in a time release manner, so that the blades remain warm throughout the time normally required to shave.

FIG. 8 illustrates a further embodiment of the invention wherein an internal heat generating source 40 is provided within the handle 12 of the razor. The heat generating source 40 is powered by batteries 42 and is adapted to heat one or more heat storing elements 30 in the neck 14, the handle 12 and/or the blade cartridge 16. In this particular embodiment, the blades 18 and/or handle of the razor may be heated for any desired length of time, so long as the batteries have sufficient power to operate the electrically powered heat generating device 40.

One or more heat storing elements may be provided in the handle 12 for warming the handle and any material contents therein, such as shave cream or gel. Further, the heat storing elements may be formed as part of the grip on the exterior of the handle.

While the present invention has been shown and described in accordance with several preferred and practical embodiments, it is recognized that departures from the instant disclosure are contemplated within the spirit and scope of the present invention.

What is claimed is:

1. A razor comprising:
a handle;
a neck extending from said handle and terminating at a distal end;
a blade carrying cartridge attached to said distal end of said neck and including at least one blade; and
at least one heat storing element structured and disposed for storing heat energy and releasing the heat energy in order to warm one or more portions of said razor.

2. The razor as recited in claim 1 wherein said heat storing element is structured, disposed and positioned for warming said at least one blade in said blade carrying cartridge.

3. The razor as recited in claim 1 wherein said blade carrying cartridge includes a plurality of blades therein.

4. The razor as recited in claim 3 wherein said heat storing element is structured, disposed and positioned for warming said plurality of blades.

5. The razor as recited in claim 1 wherein said heat storing element is structured, disposed and positioned for warming said handle.

6. The razor as recited in claim 1 wherein said heat storing element is structured, disposed and positioned for warming a shave product contained within said handle.

7. The razor as recited in claim 1 further comprising:
a plurality of said heat storing elements structured, disposed and positioned for warming said at least one blade and said handle.

8. The razor as recited in claim 1 wherein said heat energy is provided by an external heat generating source.

9. The razor as recited in claim 1 wherein said heat energy is provided by an internal heat generating source contained within said razor.

10. The razor as recited in claim 9 wherein said internal heat generating source is a battery powered heat generating device.

11. A razor comprising:
a handle;
a neck extending from said handle and terminating at a distal end;
a blade carrying cartridge attached to said distal end of said neck and including at least one blade; and
at least one heat storing element structured and disposed for storing heat energy and releasing the heat energy during a time release period of at least one minute in order to warm one or more portions of said razor throughout said time release period.

12. The razor as recited in claim 11 wherein said heat storing element is structured, disposed and positioned for warming said at least one blade in said blade carrying cartridge.

13. The razor as recited in claim 11 wherein said blade carrying cartridge includes a plurality of blades therein.

14. The razor as recited in claim 13 wherein said heat storing element is structured, disposed and positioned for warming said plurality of blades.

15. The razor as recited in claim 11 wherein said heat storing element is structured, disposed and positioned for warming said handle.

16. The razor as recited in claim 11 wherein said heat storing element is structured, disposed and positioned for warming a shave product contained within said handle.

17. The razor as recited in claim 11 further comprising:
a plurality of said heat storing elements structured, disposed and positioned for warming said at least one blade and said handle throughout said time release period.

18. The razor as recited in claim 11 wherein said heat energy is provided by an external heat generating source.

19. The razor as recited in claim 11 wherein said heat energy is provided by an internal heat generating source contained within said razor.
